(19) United States
(12) Patent Application Publication
(10) Pub. No.: US 2005/0009396 A1
(43) Pub. Date: Jan. 13, 2005

(54) EXPANDING SLOT ADAPTER OF EXPANDING CARD

(76) Inventor: Hung Sung Wu, Taipei Hsien (TW)

Correspondence Address: Hung Sung Wu, 235 Chung-Ho, Box 8-24, Taipei, TW

(21) Appl. No.: 10/354,393

(22) Filed: Jul. 11, 2003

(51) Int. Cl. H01R 13/62

(52) U.S. Cl. 439/327

(57) ABSTRACT

An expanding slot adaptor of an expanding card for receiving and electrically connected to the expanding card. One end of the expanding card is installed with a first shoulder and another end is installed with a second shoulder. The sliding slot adaptor comprises the following elements. An adaptor body has an expanding card inserting hole and a plurality of terminal holes. A sliding element is arranged on the adaptor body. The sliding element has buckles corresponding to a first and a second shoulders, respectively, so that the expanding card inserted into the adaptor body is firmly secured to the sliding element. One end of the restoring means is combined to the sliding element, and thus the sliding element is restored to an original position by the restoring means. A sliding means is formed upon the sliding element of the adaptor body.

### BACKGROUND OF THE INVENTION

(1) Field of the Invention

The present invention relates to adaptors; and particularly to an expanding slot adaptor for an expanding card having a sliding element which is restored by a restoring means to an original position.

(2) Description of the Prior Art

To enhance the function of a computer, currently, expanding card is installed to a mother board of a computer so as to achieve requirements of users by the special functions of the cards, such as AGP graphic card which is typically installed into the expanding slot adaptor of a mother board. Thereby, a movable retainer is installed to the expanding slot adaptor.

Referring to FIGS. 1A and 1B, a conventional expanding slot adaptor 14 for being engaged with an expanding card 1 is illustrated. The adaptor 14 consists of an adaptor body 2 and a retainer 3. A distal end of the bottom of the expanding card 1 are formed with a first shoulder 4 and a second shoulder 5 which are protruded at the same orientation. The retainer 3 includes an elastic frame 6 with an aperture 7 at a center portion thereof. One end of the elastic frame 6 has a grip 9, and another end thereof has a catcher 10 for actuating a resilient framework. The elastic frame 6 may be mounted outside of the adaptor body 2.

By the buckling a male buckle 11 and a female buckle 12, the catcher 10 may be closed or opened.

To install the expanding card 1 to the expanding slot adaptor 14, the first step is to set the catcher 10 open so that the male buckle 11 and the female buckle 12 are brought apart, and thus the aperture of the elastic frame 6 is scaled up to the extent sufficient to cover the adaptor body 2; next, the elastic frame 6 is engaged into the adaptor body 2, meantime the male buckle 11 and the female buckle 12 are coupled; in the third step, the expanding card 1 is inserted into the adaptor body 2, such that the check shoe 13 of elastic frame 6 is engaged into the first shoulder 4 and the second shoulder 5 is engaged to the bottom of the female buckle 12. Thereby, the expanding card 1 is steadily connected to the adaptor body 2.

Once an external force is applied against the grip 9, the check shoe 13 will be separated from the first shoulder 4. Then the expanding card 1 can be drawn out.

Above mentioned prior art structure will cause that the expanding card 1 is steadily connected to the expanding slot adaptor 14. Moreover, there are many electronic parts on a mother board and thus in use, the elastic frame 6 must be opened to a predetermined extent, for being installed to the adaptor body 2. This, it is inconvenient in use.

### SUMMARY OF THE INVENTION

Accordingly, the primary object of the present invention is to provide an expanding slot adaptor of an expanding card for receiving and electrically connected to the expanding card. One end of the expanding card is installed with a first shoulder and another end is installed with a second shoulder. The sliding slot adaptor comprises the following elements. An adaptor body has an expanding card inserting hole and a plurality of terminal holes. A sliding element is arranged on the adaptor body. The sliding element has buckles corresponding to a first and a second shoulders, respectively, so that the expanding card inserted into the adaptor body is firmly secured to the sliding element. One end of the restoring means is combined to the sliding element, and thus the sliding element is restored to an original position by the restoring means. A sliding means is formed upon the sliding element of the adaptor body.

The various objects and advantages of the present invention will be more readily understood from the following detailed description when read in conjunction with the appended drawing.

### BRIEF DESCRIPTION OF THE DRAWINGS

FIG. 1A is an exploded perspective view of a conventional expanding slot adaptor;

FIG. 1B is a cross-section view of the coupling mechanism according to FIG. 1A;

FIG. 2 is an exploded perspective view of the expanding slot adaptor;

FIG. 3 is a perspective view of the expanding slot adaptor of the present invention;

FIG. 4 is a top view, and FIG. 5 a left side view of the slide element of the invention;

FIG. 6 and FIG. 7 are front views illustrating the sliding movement of the sliding element on the adaptor body according to the present invention;

FIG. 8 and FIG. 9 are elevational views showing the operation of the sliding element on the adaptor body according to the present invention;

FIG. 10 is a top view of the grip having been pushed to a steady condition according to the present invention;

FIG. 11 and FIG. 12 are perspective view and exploded perspective view of a second preferred embodiment of the expanding slot adaptor, respectively;

FIG. 13A and FIG. 13B illustrates a frontal view and a top view of the embodiment shown in FIG. 11, respectively;

FIG. 14 and FIG. 15 are top views showing that the sliding element sliding on the adaptor body according to the present invention.

FIGS. 16 to 18 are an exploded perspective view, a rear view and a top view of the present invention.

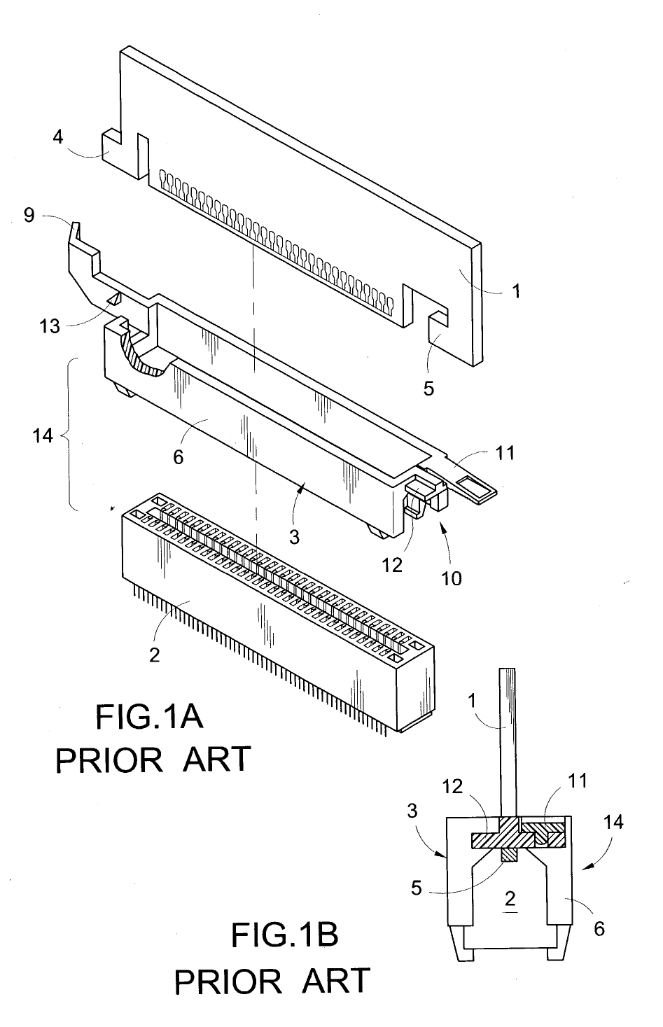

### DETAILED DESCRIPTION OF THE PREFERRED EMBODIMENT

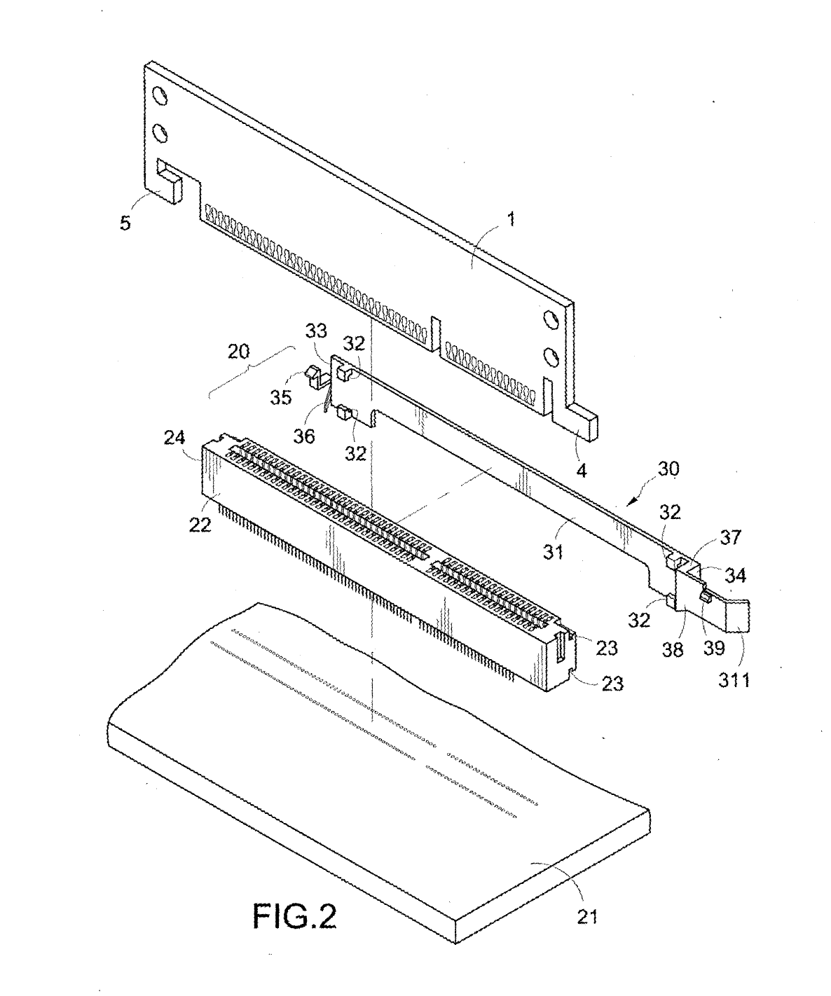

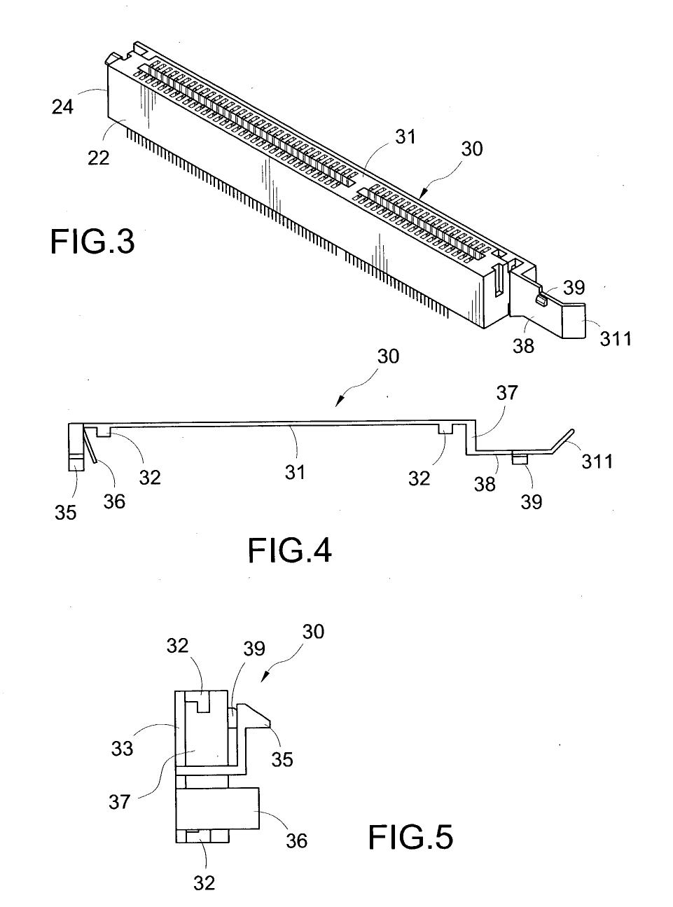

Referring to FIGS. 2 to 5, it will be seen that the expanding slot adaptor 20 for an expanding card according to the present invention is installed on a mother board 21. The expanding card 1 is vertically inserted into and electrically connected to the expanding slot adaptor 20.

The expanding slot adaptor 20 comprises an adaptor body 22 and a sliding element 30 installed at one side of the adaptor body 22. A sliding means is formed between the adaptor body 22 and the sliding element 30 for guiding the sliding element 30 to slide axially between the positions illustrated in FIGS. 8 and 9.

The adaptor body 22 is provided with an inserting slot for being inserted by the expanding card vertically. Two sides of the inserting slot have a plurality of terminal holes for being inserted by terminals.

The sliding means has a plurality of guide rails 23 and sliding slot 32. The guide rail 23 is formed on the upper and lower distal ends of the adaptor body 22. The sliding slot 32 is formed on the sliding element 30 and is configured with respect to the corresponding each guide rail 23. Each sliding rail 23 is installed to a corresponding sliding slot 32 so that sliding element 30 will cause that the buckling means to buckle a first shoulder 4 and a second shoulder 5 at two sides of the expanding card 1.

The sliding element 30 comprises a body 31. The sliding slot 32 is formed on the body 31. The body 31 has a left surface 33 and a right surface 34. A buckle 35 and a restoring means extended vertically from the left surface 33 and the buckle 35 is positioned on the second shoulder 5 of the expanding card 1 so that the expanding card 1 is steadily combined to the sliding element 30. The restoring means 36 is a flexible sheet and is formed with an acute angle with the body 31.

The right surface 34 is vertically extended with a flat bottom 37. Thereby, the sliding distance of the sliding element 30 is limited and controlled by the buckle 35 and the flat bottom 37. A plane portion 38 is extended outwards from the flat portion 37. The plane portion 38 is formed with a buckling portion 39. The buckling portion 39 is positioned above the first shoulder 4 of the expanding card 1 so that the expanding card is firmly secured and combined to the sliding element 30. Therefore the sliding element 30 is firmly secured to the expanding card 1 by buckling relation of the buckle 35 and the buckling portion 39, and the first and second shoulders of the expanding card 1. Thereby, it is further connected to the adaptor body 22.

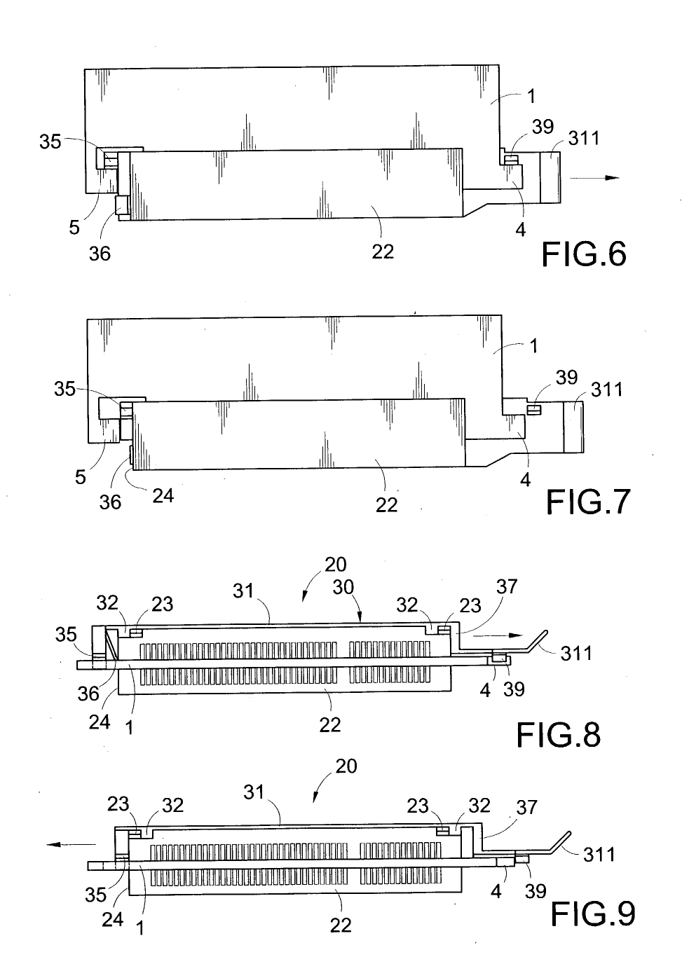

Referring to FIGS. 6 to 9, the relation of the sliding element 30 with respect to the adaptor body 22 is illustrated. As shown in FIGS. 6 and 8, when the expanding card 1 is inserted into the adaptor body 22, the buckle 35 and buckling portion 39 of the sliding element 30 are positioned above the first and second shoulders of the expanding card, respectively. Thereby, the sliding element is firmly secured and combined to the expanding card 1 so as to be connected to the adaptor body 22. Referring to FIGS. 7 and 8, the sliding element 30 moves aside until one end of the buckle 35 is flushed with the end surface 24 of the adaptor body 22. Therefore, the buckling portion 39 and buckle 35 of the expanding card 1 are separated from the first and second shoulders 4 and 5, respectively. As a result, the expanding card is free and can be fetched out.

By the reduction in distance relation of the buckle 35 and the adaptor body 22, the angle between the restoring means 36 and the adaptor body 22 will increase gradually. Therefore when the expanding card 1 is fetched out, the push force applied upon the sliding element 30. Then the restoring means 36 (may be a flexible sheet) will generate a reverse push force so that the sliding element 30 will restore to an original position automatically.

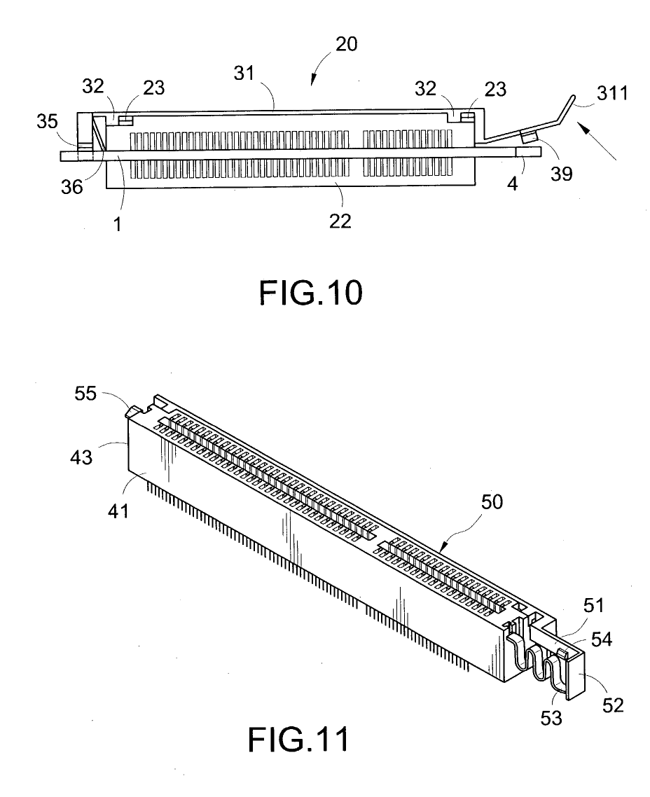

Referring to FIG. 10, an end portion 38 extends outwards with a movable piece 311. When an outer force applied to the movable piece 311 so that the expanding card can be fetched out.

It should be known that there are two ways capable of being used to fetch the expanding card 1 from the sliding slot 30, one is by using the movable piece 311, and the other is to fetch out the expanding card by the sliding element.

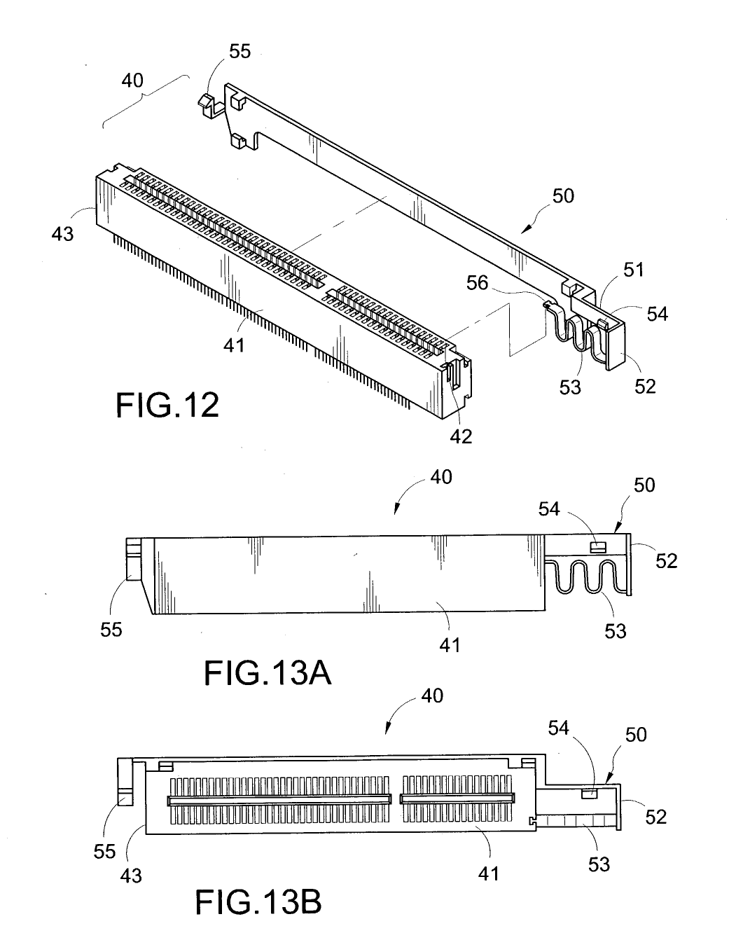

Referring to FIGS. 11 to 13B, the second embodiment about the expanding slot connector 40 of the present invention is illustrated. The plane portion 51 of the sliding element 50 has a lateral arm 52. A lower end of the lateral arm 52 is extended with a restoring means 53 and one end of the arm has a coupling protrusion 56 so that the coupling protrusion 56 can be embedded into an embedding groove 42 corresponding to the adaptor body 41. As a result, the restoring means 53 is connected to the adaptor body 41. The restoring means 53 is a curled piece.

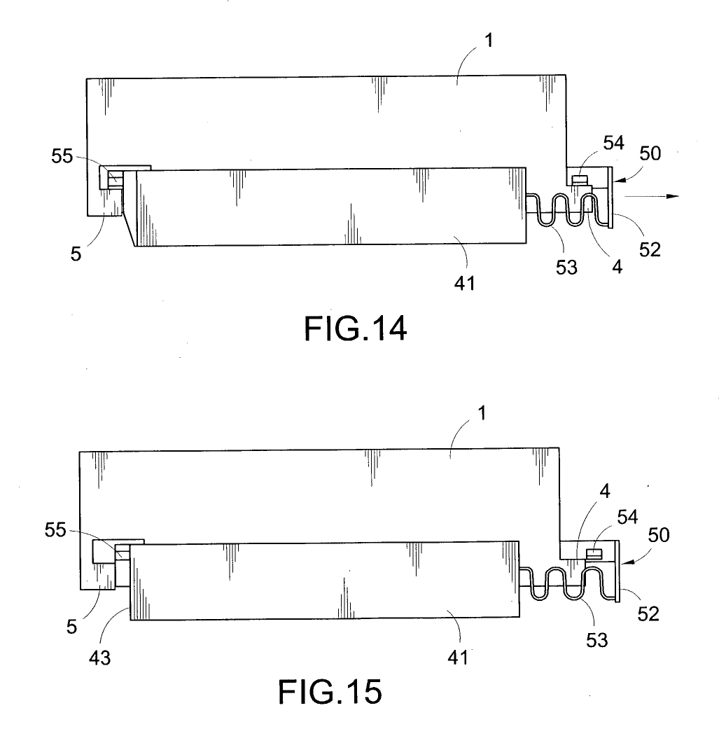

Referring to FIGS. 14 and 15, the sliding relation of the sliding element 50 on the adaptor body is illustrated. When the expanding card 1 is inserted into the adaptor body 41. The buckles 54 and 55 of the sliding element 50 are positioned above the first and second shoulders 4 and 5 of the sliding element 50, respectively so that the sliding element 50 can steadily combine the expanding card to the adaptor body 41, as shown in FIG. 14. If the expanding card 1 is to be fetched out. The lateral arm of the sliding element 50 will be pulled out until the buckle 55 is flushed with the end surface 43 of the adaptor body 41. Therefore, the buckles 54, 55 of the expanding card 1 are separated from the first and second shoulders 4 and 5, respectively. Thus, the expanding card 1 is free and the expanding card 1 can be fetched out. Then the force applied to the expanding card 1 can be released so that the sliding element 50 restores to the original position by the pull force of the restoring means (i.e., flexible sheet).

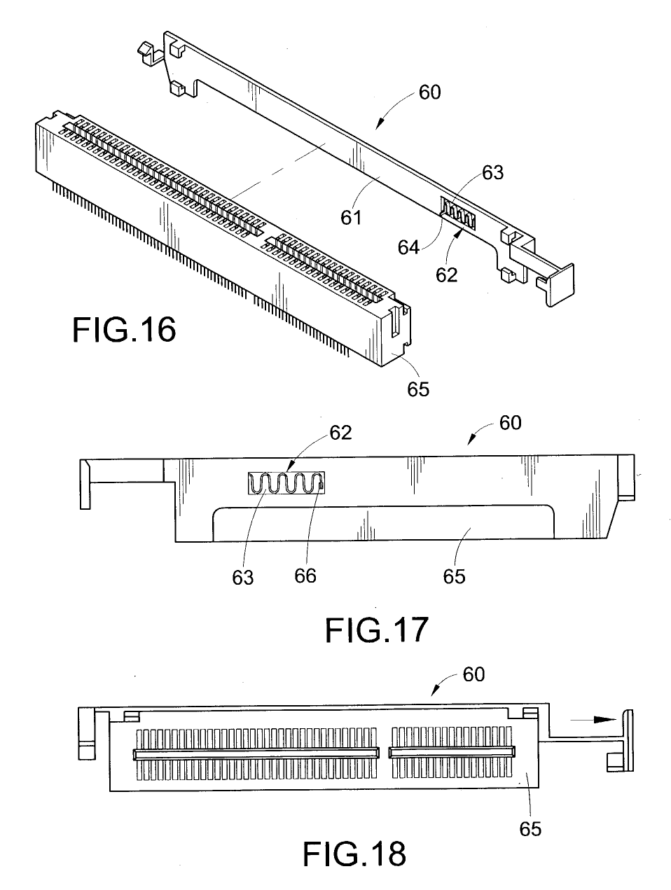

Referring to FIGS. 16 to 18, the third embodiment about the sliding slot connector of the expanding card of the present invention is illustrated. The restore means 62 can be installed to the body of the sliding element 60. The restoring means 62 is a flexible sheet since the body 61 has a rectangular hole 63. Thereby, one end of the restoring means 62 is combined to an end wall of the rectangular hole 63, and another end 64 thereof will be pulled asides. Since the restoring means 62 is pulled by a pull force, the restoring means 62 will extend until the sliding element 60 separates from the first and second shoulders and the expanding card is free so that it can be fetched out. Then the force applied to the sliding element 60 is released so that the sliding element 60 restores to the original position by the pull force of the restoring means 62.

Since in the present invention, the sliding element of the present invention is installed aside the adaptor body. Thus, it only occupies a small space and does not hinder other electronic element of the mother board and the assembly process of the expanding card is simplified. Moreover, the sliding element restores to the original position by the restoring means.

The present invention is thus described, it will be obvious that the same may be varied in many ways. Such variations are not to be regarded as a departure from the spirit and scope of the present invention, and all such modifications as would be obvious

1. An expanding slot adaptor of an expanding card for receiving and electrically connected to the expanding card; one end of the expanding card being installed with a first shoulder and another end being installed with a second shoulder; the sliding slot adaptor comprising:
an adaptor body having an expanding card inserting hole and a plurality of terminal holes;
a sliding element being arranged on the adaptor body; the sliding element having buckles corresponding to a first and a second shoulders, respectively, so that the expanding card inserted into the adaptor body is firmly secured to the sliding element;
a restoring means; one end of the restoring means being combined to the sliding element, and thus the sliding element being restored to an original position by the restoring means; and
a sliding means formed upon the sliding element of the adaptor body so that the sliding element can be coupled to or separated from the expanding card along an axially line.

2. The expanding slot adaptor of an expanding card as claimed as 1, wherein the restoring means is combined to one side of the sliding element.

3. The expanding slot adaptor of an expanding card as claimed as 1, the restoring means is combined to the sliding element.

4. The expanding slot adaptor of an expanding card as claimed as 1, wherein the sliding element further comprises a movable element at a distal end of the sliding element for separating the buckles from the expanding card.

5. The expanding slot adapter of an expanding card as claimed as 1, wherein the restoring means is a flexible sheet and is formed with an acute angle with the adaptor body, thus, a moved sliding element will restore to the original position.

6. The expanding slot adapter of an expanding card as claimed as 1, wherein sliding element is combined to the restoring means.

7. The expanding slot adapter of an expanding card as claimed as 2, wherein the restoring means is a flexible sheet and one end thereof is connected an end surface of the adaptor body; thus the sliding element can restore to the original position by the flexible sheet.

8. The expanding slot adapter of an expanding card as claimed as 3, wherein the restoring means is a flexible sheet and one end thereof is connected an end surface of the adaptor body; thus the sliding element can restore to the original position by the flexible sheet.
